(19) United States
(12) Patent Application Publication
(10) Pub. No.: US 2025/0044470 A1
(43) Pub. Date: Feb. 6, 2025

(54) SYSTEM AND METHOD FOR SEISMIC INTERPRETATION USING MULTISPECTRAL VARIANCE

(71) Applicant: Chevron U.S.A. Inc., San Ramon, CA (US)

(72) Inventor: Antonio Dario Nocioni, Houston, TX (US)

(21) Appl. No.: 18/365,023

(22) Filed: Aug. 3, 2023

(51) Int. Cl. G01V 1/30; G01V 1/36

(52) U.S. Cl. CPC G01V 1/302; G01V 1/364; G01V 2210/43; G01V 2210/642

(57) ABSTRACT

A method is described for generating multispectral variance volumes from seismic data. The method may include receiving, at a computer processor, a seismic image; analyzing the seismic image to determine frequency content and vertical seismic resolution; performing structural oriented filtering to generate a filtered seismic volume; performing spectral enhancement of the filtered seismic volume using the determined frequency content and vertical seismic resolution to generate a plurality of frequency-dependent seismic volumes; calculating covariance of the frequency-dependent seismic volumes to generate a plurality of covariance matrices; combining the covariance matrices to create a multispectral variance volume. The method is executed by a computer system.

### TECHNICAL FIELD

The disclosed embodiments relate generally to techniques for processing seismic data representative of a geologic subsurface of interest. In particular, the embodiments process seismic images that may be used for structural interpretation of geologic volumes that include salt bodies and/or high-dip features such as faults.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

Seismic data is processed to create seismic images that can be interpreted to identify subsurface geologic features including hydrocarbon deposits. It is particularly important to be able to delineate edges in the subsurface, such as faults, discontinuities, and channel edges. Conventional methods to delineate such edges may use variance volumes but these often suffer from poor signal to noise ratios and contamination by high dipping events. The ability to define the location of rock and fluid property changes in the subsurface is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for variance volumes that better delineate edges so that seismic interpretation of the geologic subsurface is more accurate.

### SUMMARY

In accordance with some embodiments, a method of generating multispectral variance volumes from seismic images is disclosed. The method may include receiving, at a computer processor, a seismic image; analyzing the seismic image to determine frequency content and vertical seismic resolution; performing structural oriented filtering to generate a filtered seismic volume; performing spectral enhancement of the filtered seismic volume using the determined frequency content and vertical seismic resolution to generate a plurality of frequency-dependent seismic volumes; calculating covariance of the frequency-dependent seismic volumes to generate a plurality of covariance matrices; combining the covariance matrices to create a multispectral variance volume; and displaying the multispectral variance volume on a graphical display. The method may also include using the multispectral variance volume to generate a seismic interpretation of the seismic image. In an embodiment, the method may perform spectral enhancement of the filtered seismic volume using Constant Bandwidth Enhancement and spectral decomposition or time-frequency analysis. In an embodiment, the method may combine the covariance matrices by combining covariance matrices for each spectral component and adding them together.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates an example system for generating a multispectral variance volume;

FIG. 2 illustrates an example method for generating a multispectral variance volume; and

FIG. 3 compares a result of an embodiment of the present invention with a result from a conventional method.

Like reference numerals refer to corresponding parts throughout the drawings.

### DETAILED DESCRIPTION OF EMBODIMENTS

Described below are methods, systems, and computer readable storage media that provide a manner of generating a multispectral variance volume to facilitate seismic interpretation. These embodiments are designed to be of particular use for seismic interpretation of geologic subsurface volumes that contain high dip events such as near-vertical faults, discontinuities, and channel edges. Variance generated from spectrally decomposed seismic volumes delineates edges that are best analyzed at or near the tuning frequency of a given formation. In general, shorter, and vertically limited faults, discontinuities and channel edges are better delineated at higher frequencies, while large listric fault systems and regional discontinuities are better delineated at lower frequencies.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

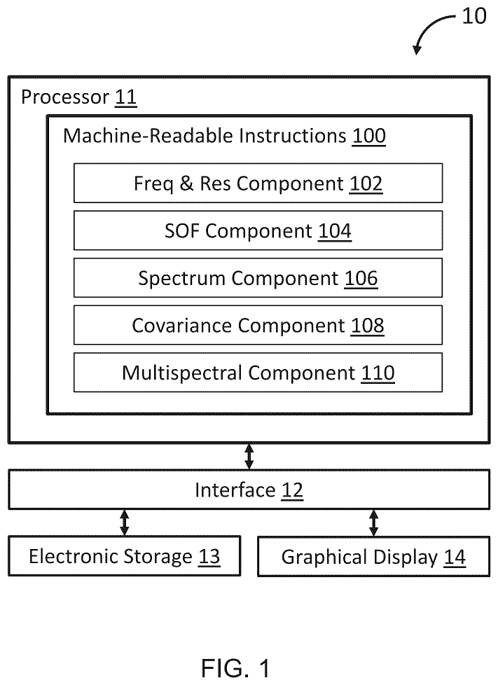

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 14, and/or other components. The processor 11 will receive a seismic image derived from a seismic dataset and will produce a multispectral variance volume to be used for interpretation of the seismic image.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to input seismic image, and/or other information. For example, the electronic storage 13 may store information relating to output multispectral variance volume, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to the seismic image, the multispectral variance volume, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate the generation of the multispectral variance volume. The machine-readable instructions 100 may include one or more computer program components. The machine-readable instructions 100 may include a frequency and resolution component 102, a structural oriented filtering (SOF) component 104, a spectrum component 106, a covariance component 108, a multispectral component 110, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the frequency and resolution component 102 may be configured to receive a seismic image and analyze the frequency content and vertical seismic resolution.

The SOF component 104 may be configured to filter the seismic image based on the structure, filtering tangentially to the primary event dips.

The spectrum component 106 may be configured to perform spectral enhancement of the seismic image. For example, it may perform spectral shaping. It will divide the seismic image into at least three seismic volumes representative of a low frequency volume, a middle frequency volume, and a high frequency volume.

The covariance component 108 may be configured to calculate covariance matrices for each of the seismic volumes generated by spectrum component 106.

The multispectral component 110 may be configured to combine the covariance matrices for each of the seismic volumes from covariance component 108 into a single multispectral variance volume. The multispectral variance volume can then be used in the seismic interpretation of the input seismic image.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

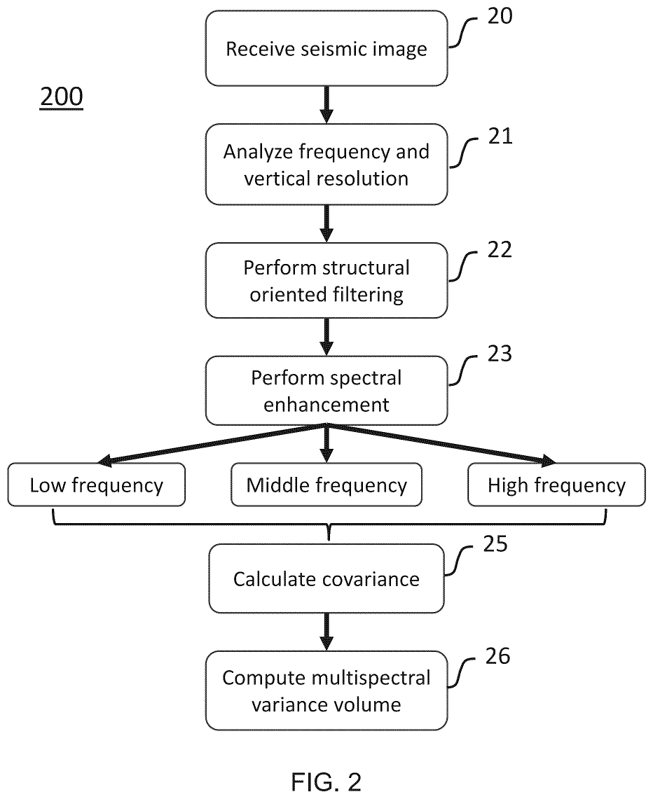

FIG. 2 illustrates an example process 200 for generating a multispectral variance volume. At step 20, a 3D seismic image is received. This 3D seismic image may have been created by a seismic imaging process, such as migration, of a seismic dataset recorded as a seismic survey for a subsurface geologic volume of interest. The present workflow is very flexible as to the input seismic data, with no limitation of where the seismic data is acquired (offshore vs onshore), in which domain the seismic was processed (time vs depth) and doesn't require any specific processing workflow. Also, this workflow can be used multiple times at different steps of an overall seismic processing workflow as an important QC tool.

At step 21, the 3D seismic image is analyzed for its frequency content and vertical seismic resolution. Seismic frequency is the number of cycles on a seismic waveform that occur within a period of time. Frequency attributes include instantaneous frequency, average frequency and tuning frequency. They identify zones of anomalous seismic attenuation and serve as rough measures of reflection spacing. Seismic resolution is the ability to distinguish between two features from one another. There are two types of seismic resolution, vertical and horizontal. Vertical resolution determines the thickness of the beds, such as two close seismic responds corresponding to different depth levels. Vertical resolution represents the distance between two interfaces as separate reflector and can be calculated from the length of the propagation wave and a layer thickness below ¼ wavelength for resolving limits of beds. The thickness of the bed model is resolvable where wavelength is equal or greater until wavelength/4. The beds that wavelength is thinner than wavelength/4, there is no distinct reflection, the vertical resolution is limited.

At step 22, process 200 performs structural oriented filtering. This will filter the seismic image based on the structure, filtering tangentially to the primary event dips. Structurally oriented filtering process smooths along structural planes as defined by dip and azimuth seismic attributes. Dip and azimuth seismic attributes are automatically calculated and doesn't require any previous seismic interpretation. It is an effective method of removing incoherent noise and increasing continuity of events, without smoothing across dipping planes. The most familiar filters are mean, median, and trim structural oriented filtering.

At step 23, process 200 performs spectral enhancement of the filtered seismic image using the information about frequency content and vertical seismic resolution from step 21. The ability to resolve seismic thin bed is a function of the bed thickness and the frequency content of the seismic data. To achieve high resolution, the seismic data must have broad frequency bandwidth. The seismic trace is a superposition of many overlapping reflections, so it is often difficult to identify the exact reflection boundaries. Therefore, there is a need for a method to enhance the frequency content of seismic data to make subtle geologic features more easily identifiable. Enhanced seismic data shows a significant increase in resolution resulting in detailed reservoir stratigraphy, clearer pinchouts and structures as the event can appear more sharply defined and less affected by low frequency noise. Spectral enhancement is the process to achieve that. There are several spectral enhancement methods. In an embodiment, the spectral enhancement method used is Constant Bandwidth Enhancement. The next step is to perform spectral decomposition or time-frequency analysis. Spectral decomposition is a technology developed in the last decade. It has proven to be very useful for seismic data interpretation because decomposing data into its spectral components reveals stratigraphic and structural details that are often obscured in the broadband data. Spectral decomposition is a technique that breaks down seismic signal into narrow frequency sub-bands. In a geologically complex area, target events' variations in amplitude as a function of frequency can be traced more clearly when viewed in terms of a frequency band. Lithology- and fluid-driven spectral variations, such as peak frequency shifting due to attenuation and absorption, can be better delineated. Thus, spectral decomposition provides a technique to help seismic interpretations. Spectral decomposition unravels the seismic signals into its constituent frequencies. This allows the interpreter to see amplitude and phase tuned to specific wavelengths, just as a radio can pick out a single station or a prism a single color. Spectral decomposition can be performed on either time migrated and depth migrated data and results in tuning frequencies with units of Hz and cycle/distance, respectively. There are different methods to perform spectral decomposition (by way of example and not limitation, Fourier Transform; Continuous Wavelet Transform “CWT”; Matching Pursuit, between others). Each method has advantages and disadvantages. The frequency split in three volumes were done using matching pursuit algorithm. This method has a better seismic vertical resolution that the other methods and can be apply at reservoir scale analysis. The frequencies included in each volume will depend on the frequency content and seismic vertical resolution found in step 21 and the spectral enhancement and shaping performed in step 23. By way of example and not limitation, the low frequency volume in time domain may contain events in the frequency range of 5-15 Hz, the middle frequency volume may contain events in the frequency range of 15-30 Hz, and the high frequency volume may contain events in the frequency range of 30-60 Hz.

At step 25, each of the frequency volumes generated by step 23 has its covariance matrix calculated. Covariance matrices represent the covariance values of each pair of variables in multivariable data. These values show the distribution magnitude and direction of multivariate data in a multidimensional space and can provide information about how data spreads among two and/or three dimensions. In some embodiments, the covariance is calculated following these steps:
1—Calculate the mean of each variable in the data set.
2-Subtract the mean from each data point in each variable to center the data around zero.
3—Calculate the product of the centered data points for each pair of variables.
4—Sum the products and divide by the number of data points minus one. This gives the covariance between the variables.
5—Repeat steps 3 and 4 for all possible pairs of variables in the dataset to create a covariance matrix. All these processes are performed by the computer and were automated using scripts.

At step 26, the covariance matrices from step 25 are combined to generate one multispectral variance volume. Variance attributes computed from spectral voice components often provide sharper images, with the “best” component being a function of the tuning thickness and the reflector alignment across faults. Although one can co-render three variance images using red-green-blue (RGB) blending, a display of the information contained in more than three volumes in a single image is difficult. The multispectral variance techniques address this problem by combining covariance matrices for each spectral component, adding them together, resulting in a “multispectral” variance algorithm. The multispectral variance images provide better images of channel and faults, and they are less noisy than those computed from the full bandwidth data.

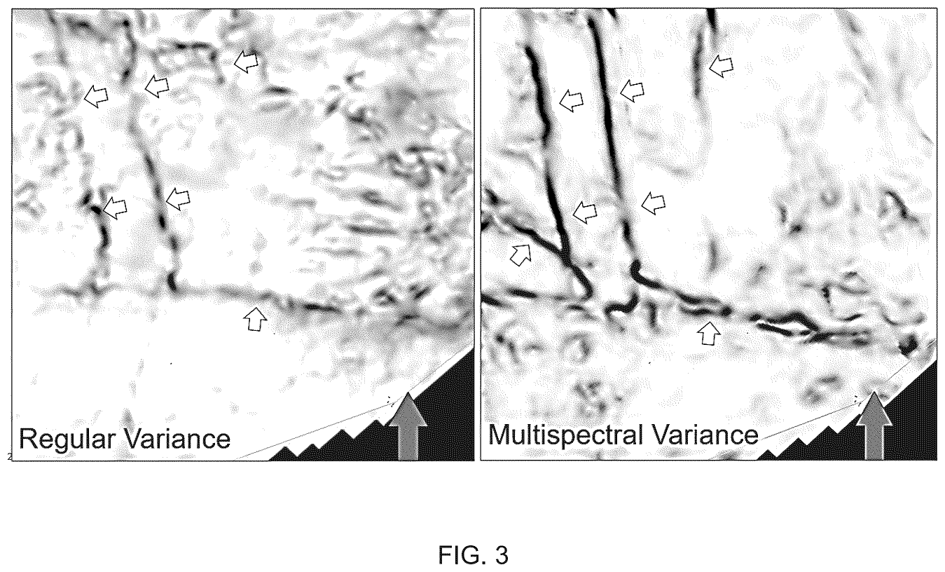

The multispectral variance volume will illustrate events within the volume that represent edges that were present in the input seismic image but potentially difficult to see. Compared to conventional methods used to delineate edges in a seismic image, the multispectral variance will have better definition of faults and other discontinuities and reduced contamination caused by high dipping events. This is illustrated in FIG. 3, where a conventional regular variance depth slice is shown on the left and a result of the method 200 is shown on the right. The white arrows lined by black point out particular areas where the definition of the faults is clearly better using method 200; the gray arrow demonstrates an area where the conventional result is contaminated with an artifact while the multispectral variance is clean. The multispectral variance volume can be used to improve the structural-stratigraphic interpretation of the seismic image, thereby allowing better planning of future seismic surveys, obtaining mineral and lease rights, signing well commitments, permitting rig locations, designing well paths, drilling strategy, and the like for the purpose of producing (i.e., extracting) hydrocarbons from the subsurface.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising:
a. receiving, at a computer processor, a seismic image;
b. analyzing the seismic image to determine frequency content and vertical seismic resolution;
c. performing structural oriented filtering to generate a filtered seismic volume;
d. performing spectral enhancement of the filtered seismic volume using the determined frequency content and vertical seismic resolution to generate at least three frequency-dependent seismic volumes;
e. calculating covariance of the at least three frequency-dependent seismic volumes to generate at least three covariance matrices;
f. combining the at least three covariance matrices to create a multispectral variance volume; and
g. displaying the multispectral variance volume on a graphical display.

2. The method of claim 1 further comprising using the multispectral variance volume to generate a seismic interpretation of the seismic image.

3. The method of claim 1 wherein the performing spectral enhancement of the filtered seismic volume comprises Constant Bandwidth Enhancement and spectral decomposition or time-frequency analysis.

4. The method of claim 1 wherein the combining the at least three covariance matrices comprises combining covariance matrices for each spectral component and adding them together.

5. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive, at the one or more processors, a seismic image;
b. analyze, via the one or more processors, the seismic image to determine frequency content and vertical seismic resolution;
c. perform, via the one or more processors, structural oriented filtering to generate a filtered seismic volume;
d. perform, via the one or more processors, spectral enhancement of the filtered seismic volume using the determined frequency content and vertical seismic resolution to generate at least three frequency-dependent seismic volumes;
e. calculate, via the one or more processors, covariance of the at least three frequency-dependent seismic volumes to generate at least three covariance matrices;
f. combine, via the one or more processors, the at least three covariance matrices to create a multispectral variance volume; and
g. display the multispectral variance volume on a graphical display.

6. The system of claim 5 further comprising using the multispectral variance volume to generate a seismic interpretation of the seismic image.

7. The system of claim 5 wherein the performing spectral enhancement of the filtered seismic volume comprises Constant Bandwidth Enhancement and spectral decomposition or time-frequency analysis.

8. The system of claim 5 wherein the combining the at least three covariance matrices comprises combining covariance matrices for each spectral component and adding them together.

9. A non-transitory computer readable storage medium storing one or more programs, the one or more programs comprising instructions, which when executed by an electronic device with one or more processors and memory, cause the device to:
a. receive, at one or more processors, a seismic image;
b. analyze, via the one or more processors, the seismic image to determine frequency content and vertical seismic resolution;
c. perform, via the one or more processors, structural oriented filtering to generate a filtered seismic volume;
d. perform, via the one or more processors, spectral enhancement of the filtered seismic volume using the determined frequency content and vertical seismic resolution to generate at least three frequency-dependent seismic volumes;
e. calculate, via the one or more processors, covariance of the at least three frequency-dependent seismic volumes to generate at least three covariance matrices;
f. combine, via the one or more processors, the at least three covariance matrices to create a multispectral variance volume; and
g. display the multispectral variance volume on a graphical display.

10. The device of claim 9 further comprising using the multispectral variance volume to generate a seismic interpretation of the seismic image.

11. The device of claim 9 wherein the performing spectral enhancement of the filtered seismic volume comprises Constant Bandwidth Enhancement and spectral decomposition or time-frequency analysis.

12. The device of claim 9 wherein the combining the at least three covariance matrices comprises combining covariance matrices for each spectral component and adding them together.
